(19) United States
(12) Patent Application Publication
(10) Pub. No.: US 2026/0087296 A1
(43) Pub. Date: Mar. 26, 2026

(54) Flexible Electronic Tag for Application on a Product and Product Comprising the Flexible Electronic Tag

(71) Applicant: AUTHENA AG, Zug (CH)

(72) Inventors: Milosz TOKARSKI, Wroclaw (PL); Dejan MILENOVIC, Horgen (CH); Matteo PANZAVOLTA, Rüschlikon (CH)

(21) Appl. No.: 19/108,770

(22) PCT Filed: Sep. 4, 2023
(86) PCT No.: PCT/EP2023/074154

§ 371 Date: Mar. 5, 2025

(30) Foreign Application Priority Data
Sep. 8, 2022 (CH) CH001052/2022

(51) Int. Cl. G06K 19/077

(52) U.S. Cl. CPC G06K 19/07726; G06K 19/07722

(57) ABSTRACT

The present disclosure relates to a flexible electronic tag for tamper detection, the flexible electronic tag comprising a radio frequency identification circuit and a tamper loop circuit connected to the radio frequency identification circuit, the flexible electronic tag further comprising a flexible inlay and at least two precuts. The flexible inlay has a flat and elongated shape, comprising a first portion, which comprises the radio frequency identification circuit, and a second portion, which extends laterally from the first portion, and which comprises at least partially the tamper loop circuit. The at least two precuts, which extend from two opposite outer edges of the second portion of the flexible inlay into the flexible inlay beyond the half width of the flexible inlay, and the tamper loop circuit extends beyond the at least two precuts into the second portion of the flexible inlay.

### FIELD OF THE DISCLOSURE

The present disclosure relates to a flexible electronic tag for tamper detection, to a product with the flexible electronic tag and to a packaging for a product with the flexible electronic tag. Specifically, the present disclosure relates to a flexible electronic tag for tamper detection comprising a radio frequency identification circuit and a tamper loop circuit.

### BACKGROUND OF THE DISCLOSURE

Known tags are attached to a product container or products themselves, for example by a tie, or by using an adhesive (i.e. a tag in the form of a label). Simple tags are used to record information about the product, for example a product name, product manufacturer, instructions related to the use of the product, certifications related to the product, etc. Tags can also feature a printed machine-readable visual code, for example in the form of a barcode or a QR code, which enables a barcode scanner, for example, to identify the product. These types of tags are typically made from die-cut plastics, papers, metals, or other materials and have information printed on them. Such tags are in everyday use, from food items to cardboard shipping boxes.

More recent developments in the field of tags include the use of electronic circuitry, in particular radio frequency identification (RFID) circuitry, to allow a product scanner to read digital information from the tag electronically. RFID tags have some advantages over machine-readable visual code, for example, they do not require a line of sight with a scanner, and they are able to store more data. Such tags are gaining widespread use, for example in the airline industry, where luggage is typically tracked using an adhesive tag containing an RFID circuit.

Tamper-evident labels are also known which have one or more indicators or barriers to entry which, if breached or missing, provide visible evidence that tampering has occurred. Items such as over-the-counter drugs and packaging materials use these types of labels on their products. Tamper-evident labels are attached to the product or container in such a way as to prevent access to the product or container without leaving visible evidence.

Electronic tags, with a tamper detection, are used for products that have a packaging or a product comprising a lid or a cover that can be opened. They combine the tamper-evident labels with RFID tags. Conventionally, these electronic tags are, for example, glued onto a product. It is particularly easy to remove conventional electronic tags from the product by carefully scraping the edge of the flexible electronic tag with a slim tool to lift the tag such as a fingernail or a knife. Conventionally, it is possible to remove the flexible electronic tag without destroying it from the product or from the packaging of the product if done so by iteratively lifting the tag from the outside towards the inner part. For example, someone might lift the conventional electronic tag from a packaging, remove the product out of the packaging, close the packaging and place the conventional flexible electronic tag back on the packaging, without leaving a trace. A conventional solution to make the removal of the conventional electronic tags more difficult is to use a very strong glue for attaching of the electronic tags on the product. This creates new problems, in particular it could be very hard to open a packaging, which has an electronic tag attached across a closed openable part of the packaging, in particular for elderly people or young people.

U.S. Pat. No. 7,876,221 B2 relates to a seal having an IC tag, which is to be attached to cover a bordering part between the cover and main body of a container. The seal has a base member serving as a support, an antenna provided on one surface of the base member and having a slit, an IC chip connected to the antenna and provided on the antenna, and an adhesive layer provided on that surface of the base-member on which the antenna and the IC chip are provided. Neither a tamper loop nor cuts extending far in the seal are disclosed in this document.

US 2013/068842 A1 relates to a RFID tag structure having anti-reuse function, comprising a substrate; a pattern formed on a surface of the substrate; and an adhesive layer provided on a surface of the pattern which is not in contact with the substrate, wherein the adhesive forces of the adhesive layer are stronger than the binding strengths generated between the pattern and the substrate, and the adhesive layer is capable of being adhered on an article to be adhered and a RFID tag is formed thereby; when the RFID tag is separated from the article to be adhered, the substrate is released from the article to be adhered, the pattern and the adhesive layer are still remained on the article to be adhered, thereby preventing the RFID tag from being reused and fulfilling the objective of anti-reuse and anti-counterfeit. The cutting lines do not extend far beyond into the RFID tag.

US 2019/135501 A1 relates to a bottle having a sealing device and a substrate attached thereto, and methods of attaching the substrate to the bottle. Methods include placing the substrate on the bottle, the bottle having a break line, and the substrate having a wireless communication device having an antenna, an integrated circuit, and a sensing line thereon. Methods further include adhering a first part of the substrate including the antenna to a first portion of the bottle that does not include the break line, and a second part of the substrate including the sensing line to a second portion of the bottle and on/over a break line. The bottle includes an interface between the sealing device and defines a break line. The substrate including the wireless communication device is on/over the bottle, at least a part of the sealing device and the break line. The break lines do not extend far beyond into the sealing device.

KR 101 315 913 B1 relates to a micro RFID tag for wine forgery protection comprises a cover sheet, a label tag, and an adhesive. The cover sheet consists of a field effect transistor (FET) material. The label tag comprises a resonant circuit printed pattern including an RFID integrated circuit (IC) chip in the rear of the cover sheet. The adhesive is provided in the rear of the label tag to attach the RFID tag. The tag is not flexible or elongated and the perforations do not extend far beyond into the tag.

### SUMMARY OF THE DISCLOSURE

It is an object of the present disclosure to provide a flexible electronic tag for tamper detection, a product with the flexible electronic tag and a packaging with the flexible electronic tag. In particular, it is an object of the present disclosure to provide an flexible electronic tag for tamper detection, a product with the flexible electronic tag and a packaging with the flexible electronic tag, which do not have at least some of the disadvantages of the prior art.

According to the present disclosure, these objects are addressed by the features of the independent claims. In addition, further advantageous embodiments follow from the dependent claims and the description.

According to the present disclosure, a flexible electronic tag for an attempted tamper detection is specified. The flexible electronic tag for attempted tamper detection comprises a radio frequency identification (RFID) circuit and a tamper loop circuit connected to the radio frequency identification circuit. The RFID circuit and the tamper loop circuit are connected, in the sense of the tamper loop circuit shares an electric wiring with at least a part of the RFID circuit. The flexible electronic tag further comprises a flexible inlay having a flat and elongated shape. The flexible inlay is flat in order not to be substantially changing a shape of a product or packaging it is attached to and in order not to be easily damaged during physical movement, handling and shipping. Other advantages of this shape is to save physical space and that it can more easily be attached across a slit or opening of a packaging. The flexible inlay comprises a first portion, which comprises the radio frequency identification circuit, and a second portion, which extends laterally from the first portion, and which comprises at least partially the tamper loop circuit. In other words, the flexible electronic tag comprises a flexible inlay or flexible layer with two portions separated by a virtual boundary and the radio frequency identification circuit is comprised by a first portion and the tamper loop circuit is at least partially comprised by a second portion, though the tamper loop circuit originates from the first portion comprising the radio frequency identification circuit, because the two circuits are connected and the virtual boundary between the two portions can be set arbitrarily as long as the RFID circuit remains in the first portion. The flexible electronic tag further comprises according to the present disclosure at least two precuts, which extend from opposite outer edges of the second portion of the flexible inlay into the flexible inlay beyond the half width of the flexible inlay, and wherein the tamper loop circuit extends beyond the at least two precuts into the second portion of the flexible inlay. In other words, the tamper loop circuit, originating from and returning to the radio frequency identification circuit in the first portion, extends, within the second portion beyond the at least two precuts. In other words, the flexible inlay area around the inner end of the precuts is the place of tension concentration, which reduces the required force to break the flexible inlay. The place of tension concentration enables to break the flexible electronic tag advantageous easily compared to a standard tag without precuts or standard tag with one precut made in standard way without extending the half of the width of the tag, in particular because the two precuts extend according to the present disclosure beyond the half width of the flexible inlay. The flexible electronic tag comprising the precuts according to the present disclosure enables to open a packaging, which comprises the flexible electronic tag attached across a closed openable part of the packaging, advantageous easily compared to standard tags, in particular for very young or elderly people. One field of application could be in medicine packaging, which would still be openable for elderly people, because the required force to break the flexible electronic tag is reduced, due to the pre-cuts, compared to a standard electronic tag. Further, an attempted removal of the flexible electronic tag may comprise trying to lift the flexible electronic tag from the product by inserting a slim tool such as a fingernail between the flexible electronic tag and the product. By doing so, it is inevitable to apply mechanical forces onto the flexible electronic tag. These forces are transmitted to the flexible inlay, which induces shear forces, in particular at the precuts area, even more particular at the inner end of the precuts. By inserting, for example the slim tool, the flexible inlay being part of the flexible electronic tag has a higher chance of being at least partially torn compared to a flexible electronic tag not having a precut. Such an at least partial tear is advantageously visible for a person inspecting the product with the flexible electronic tag and therefore, an attempted removal can be detected advantageously. The flexible electronic tag according to the present disclosure provides therefore additionally an anti-counterfeit advantage compared to standard tags. Overall, the flexible electronic tag comprising the precuts creates the advantage that a smaller force is needed to break the flexible inlay and the therefore to interrupt the tamper loop compared to standard tags, which is advantageous in respect to conventional electronic tags.

In an embodiment, the radio frequency identification circuit of the flexible electronic tag is configured to detect attempted tampering by means of an interruption of the tamper loop circuit. The tamper loop circuit can be interrupted by physical damage to it. This physical damage can result from external influence on the flexible electronic tag, for instance someone tearing on it. As the radio frequency identification circuit and the tamper loop circuit are connected by sharing, for example, an electric wiring, an interruption of the tamper loop circuit results in no current flowing through the shared circuit, which is detectable by the radio frequency identification circuit. This embodiment provides therefore the advantage that a tamper detection does not need to rely on visual detection, for example of a slit, but can be performed electronically and over-air. In particular, an RFID circuit that is part of an RFID system can forward the Boolean information of attempted tampering to an RFID reader. RFID detection ranges, thus the communication between an RFID system and a RFID reader, can reach over several meters, and even further for active RFID systems. In such a case, a single RFID reader can read a large quantity of entities, each carrying such a flexible electronic tag, within seconds, compared to a visual inspection, that would have to be done by a person or an optical system, which would need visual accessibility and potential rearrangement of entities.

In an embodiment, at least one of the radio frequency identification circuit or the tamper loop circuit is/are arranged within the flexible inlay. In other words, the circuits are not arranged, for example, on top or below the flexible inlay, but within it. This has the advantage of potentially having the circuits covered by parts of the flexible inlay and therefore at least partially protected from dust and electrical discharge. For example, the flexible inlay may comprise two layers between which the radio frequency identification circuit and/or the tamper loop is/are arranged.

In an embodiment, the flexible electronic tag comprises a product adhesion layer, which is arranged on a product side of the flexible inlay and which is configured to attach the flexible electronic tag to a product or a packaging. In other words, the flexible electronic tag is at least partially attachable to a product or product including a packaging via the product adhesion layer. The product adhesion layer may be a thin liquid adhesive film or coating or can comprise a chemically adhesive material such as glue. The product adhesion layer provides an advantageously simple and reliable solution to attach the flexible electronic tag to the product.

In an embodiment, the flexible electronic tag comprises a cover layer, which is configured to cover the flexible inlay, and wherein the flexible electronic tag further comprises a cover adhesion layer, which is arranged between the flexible inlay and the cover layer and which is configured to attach the cover layer to the flexible inlay. The cover layer advantageously protects the flexible inlay and the circuits on the flexible inlay from dust and electrical discharge. The cover adhesion layer can comprise a mechanically (or chemically) adhesive material such as glue, preferably an acrylic based adhesive. The cover layer is for example made of paper, nylon, polyethylenterephthalat, polypropylene or a combination thereof.

In an embodiment, the product adhesion layer and/or cover adhesion layer comprises an acrylic adhesive. An acrylic adhesive (also known as methylmethacrylate, acrylate, or MMA) is a resin-based, two-part adhesive comprised of acrylic or methylacrylic polymers. They are advantageously strong and efficient in bonding multiple objects together and are very environmentally resistant, and provide therefore the required bonding properties to attach the flexible inlay to the product and/or the cover layer to the flexible inlay. The specific composition of the product adhesion layer and/or cover adhesion layer may vary with respect to each other.

In an embodiment, the cover layer comprises the same precuts as the flexible inlay. In other words, the at least two precuts extends through the flexible inlay and the cover layer at the same position. The cover layer comprises material of added tear strength. By adding the precuts, similar as in the case of the flexible inlay, a position of weakest tear strength is introduced by the precuts. Because the precuts of flexible inlay and cover layer are at the same location, the flexible electronic tag has a location of overall weakest tear strength, at which the flexible electronic tag might be at least partially torn in case of attempted tampering.

In an embodiment, in addition to cover layer and flexible inlay, also the product adhesion layer and the cover adhesion layer comprise precuts at the same location if viewed from a perspective perpendicular to the flat and elongated plane of the flexible electronic tag. The more layers comprise the precuts at the same location, the more sensitive the point of weakest tear strength is to tearing during attempted tampering, as is described in previous embodiments.

In an embodiment, the flexible inlay is made of Polyethylenterephthalate (PET), Polypropylene (PP), nylon plastics, paper or a combination thereof. These materials can be fabricated in a flat and elongated shape and can still be flexibly bendable. The tear-resistance is still high enough to propagate an outward force to the precuts, but low enough such that attempted tampering results in a tear in the precuts.

In an embodiment, the second portion of flexible inlay has a substantially rectangular elongated shape. A substantially rectangular shape is more easily applied across a slit of a product or product packaging than a flexible inlay of a shape with no corners. Other shapes are also conceivable.

In an embodiment, the precuts extend with respect to an edge of the flexible inlay perpendicular or at an acute angle into the second portion of the flexible inlay. The acute angle is for example between 30° and 90 ° preferably at 45°.

In an embodiment, the flexible inlay comprises a three or more precuts which extend from two opposing edges into the second portion of the flexible inlay. For example, two of the precuts extends from a first edge into the flexible inlay and another one of the precuts extends from a second edge, arranged opposite to the first edge, into the flexible inlay. In other words, the precuts are directed on trend towards each other or towards each other with an offset. In such a case, a potential at least partial tear will with high probability take course between the two endpoints of the precuts or from one precut to the opposite flexible electronic tag side of the precut. The advantage of successfully locating the potential at least partial tear is that the delicate RFID circuit can be protected from harm and the tamper loop circuit can be placed to run through that area.

In an embodiment, the precuts extend in parallel with respect to each other into the second portion. In other words, the precuts are arranged on the same or more preferably different or most preferably on opposing sides parallel to each other. For example, the opposing precuts are preferably displaced by an offset and extend beyond the half width of the second portion of the flexible inlay into the second portion. In such a case, a potential at least partial tear will with high probability take course between the two endpoints of the precuts or from one precut to the opposite flexible electronic tag side of the precut.

In an embodiment, the tamper loop circuit is routed at least partially along a first side of at least one of the precuts, thereby following at least partially the shape of this precut. In other words, the tamper loop circuit, in particular its electric wiring, follows the precut along one side, in particular at an essentially constant distance to the precut, for at least part of that side. By doing so, a potential attempted removal can advantageously cause a cut through the tamper loop circuit. Such an attempted tampering can be detected by the RFID circuit based on previously described embodiments.

In an embodiment, the tamper loop circuit is further routed around an inner end of at least one of the precuts and at least partially along a second side, opposing to the first side, of at least one of the precuts, thereby following at least partially the shape of at least one of the precuts. In other words, the tamper loop circuit, for example its electric wiring, follows at least one of the precuts along two opposing sides, in particular at an essentially constant distance to the respective precut, for at least parts of the sides. In that, the tamper loop circuit also passes by the area of the inner end or the inner tip of the precut. As this is a point of tension concentration and therefore a point of high probability of tearing/cracking in case of externally applied forces. According to this embodiment, the probability of the tamper loop circuit interruption is advantageously increased.

In an embodiment, the flexible electronic tag is a passive tag, which is powered by energy from the RFID reader's interrogating radio waves. In another embodiment, the flexible electronic tag is an active tag, which is powered by a battery and thus can be read at a greater range from the RFID reader.

In an embodiment, the precuts are formed by punching a corresponding punching tool through the flexible inlay. It is preferred that the flexible electronic tag is formed by attaching the cover layer to the flexible inlay and to punch afterwards the at least two precut through the entire flexible electronic tag, such that the precuts extend through the flexible inlay and the cover layer.

In another embodiment, the precuts are punched only through the flexible inlay and the cover layer is attached afterwards on the flexible inlay. According to this embodiment are the precuts not visible from the outside on the flexible electronic tag.

The flexible electronic tag according to the present disclosure advantageously will detect the attempted tampering, because the likelihood that the tamper loop circuit will be interrupted by a tear is very high. The RFID circuit can detect this interruption as it is connected to the tamper loop circuit. Radio-frequency identification (RFID) uses electromagnetic fields to automatically identify and track tags attached to objects. An RFID system consists typically of a tiny radio transponder, a radio receiver and transmitter. When triggered by an electromagnetic interrogation pulse from a nearby RFID reader device, the tag transmits digital data, usually an identifying inventory number, back to the reader. This number can be used to track inventory goods or to transmit data from the product to the RFID reader device like a smartphone. In addition, according to embodiments disclosed herein, the RFID system can transmit the information on attempted tampering to a nearby RFID reader device.

According to a further aspect of the present disclosure, a packaging for a consumer product comprising a flexible electronic tag is specified, according to one of the preceding embodiments, in particular attached across a closed openable part of the package.

According to the present disclosure, a consumer product comprising a flexible electronic tag is specified, according to one of the preceding embodiments, in particular attached across a closed openable part of the consumer product.

In a further embodiment, the radio frequency identification circuit may comprise a near field communication (NFC) circuit, a low frequency (LF) communication circuit, a ultra high frequency (UHF) communication circuit, a combination thereof and/or any other kind of RFID communication circuit.

It is to be understood that both the foregoing general description and the following detailed description of present embodiments are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The present disclosure will be explained in more detail, by way of example, with reference to the drawings in which:

FIG. 1: shows a schematic top view of a mechanical breaking of a conventional flexible electronic tag;

FIG. 2: shows a schematic top view of an embodiment of the flexible electronic tag;

FIG. 3: shows a schematic exploded view of an embodiment of the flexible electronic tag;

FIG. 4: shows a schematic top view of a mechanical breaking of the flexible electronic tag according to the embodiment;

FIG. 5: shows pictures from a top view perspective of a mechanical breaking of the flexible electronic tag according to the embodiment;

FIG. 6: shows schematically a packaging of a product comprising the flexible electronic tag;

FIG. 7: shows schematically the packaging of FIG. 6, wherein the packaging has been opened and the flexible electronic tag has been torn apart.

### DETAILED DESCRIPTION OF THE EMBODIMENTS

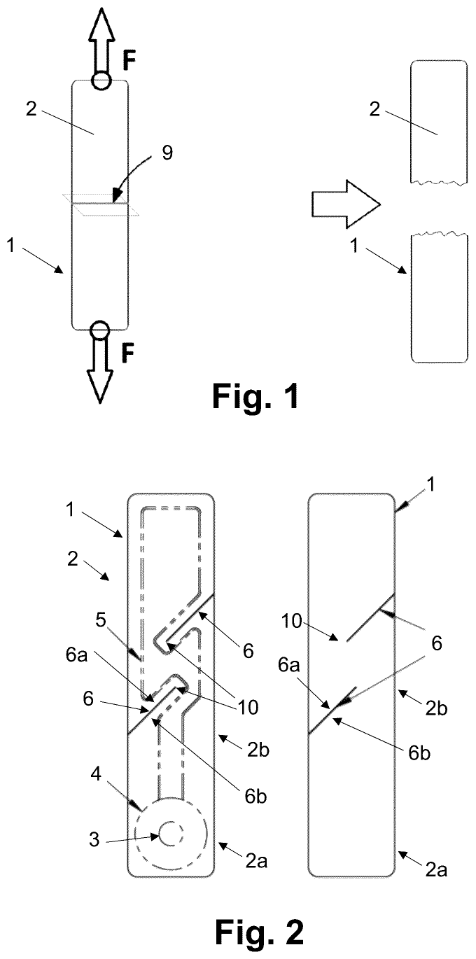

FIG. 1 shows a flexible electronic tag 1 according to state of the art. FIGS. 2 to 7 show an embodiment of a flexible electronic tag 1 according to the present disclosure.

FIG. 1 shows a top view of a mechanical breaking of a conventional tag 1. The tag 1 might comprise an inlay 2. If a force F directed outward is applied to the outer ends of the inlay 2, the inlay 2 and thus the tag 1 will typically tear along a cross-sectional area 9 perpendicular to the applied force. This tear or cut might be anywhere along the flexible electronic tag 1, as the point of weakest tear strength at the edges of the inlay 2 is arbitrary. Furthermore, the force F that needs to be applied to have an initial tear or cut forming is hardly controllable and dependent on the specific properties of a single tag 1. The left part of FIG. 1 shows the conventional tag 1 prior to be torn apart and the right part of FIG. 1 shows the same conventional tag 1 after being torn apart.

FIG. 2 shows a top view of an embodiment of the present disclosure of the flexible electronic tag 1 with precuts 6. The flexible electronic tag 1 comprising an essentially rectangular flexible inlay 2 with two portions 2a and 2b, which are separated by a virtual boundary (not shown). The first portion comprising a radio frequency identification (RFID) circuit 3 and an antenna 4 connected to the RFID circuit 3. A RFID system comprising the RFID circuit 3 and the antenna 4 can have different forms of implementation. Connected to the RFID circuit 3 is a tamper loop circuit 5 that originates in the first portion 2a of the flexible inlay 2 and takes course along the edges and the precuts 6 of the elongated rectangular second portion 2b of the flexible inlay 2. In taking course around the precuts 6, the tamper loop circuit 5 also runs along a first side 6a of the precut 6 and a second side 6b of the precut 6 opposite to the first side 6a. Taking course around the edges and precuts 6 means that the electrical wiring has in particular at least partially a constant distance to the edge of the flexible inlay 2 and the precuts 6, for example at a distance of more than three times the width of the electrical wiring of the tamper loop circuit 5.

The RFID circuit 3 and the tamper loop circuit 5 can be placed on or into the flexible inlay 2 by photo etching, photoengraving and/or photolithographic procedures. The flexible inlay 2 can be made of Polyethylenterephthalate (PET), Polypropylene (PP), nylon plastics, paper or a combination thereof. These materials can be fabricated in a flat and elongated shape and can still be flexibly bendable. The tear-resistance is still high enough to propagate an outward force to the precuts, but low enough such that attempted tampering results in a tear in the precuts.

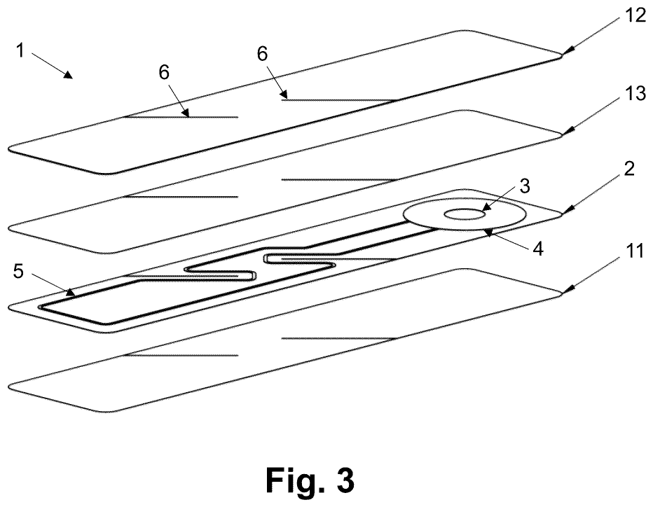

FIG. 3 shows an exploded view of the embodiment of the flexible electronic tag 1 with precuts 6. In addition to the flexible inlay 2 comprising the radio frequency identification circuit 3 and the tamper loop circuit 5 as described above, the flexible electronic tag 1 comprises a product adhesion layer 11 arranged on a product side of the flexible inlay 2 in order to be attachable to a product. In addition, the flexible electronic tag 1 comprises a cover layer 12 on a top side of the flexible inlay 2, which is opposite to the product side, and a cover adhesion layer 13 arranged between the cover layer 12 and the flexible inlay 2.

The product adhesion layer 11 and the cover adhesion layer 13 are for example made of an adhesive material such as an acrylic adhesive. An acrylic adhesive (also known as methylmethacrylate, acrylate, or MMA) is a resin-based, two-part adhesive comprised of acrylic or methylacrylic polymers. They are advantageously strong and efficient in bonding multiple objects together, are very resistant to environmental influence, and provide therefore the required bonding properties to attach the flexible inlay 2 to the product and/or the cover layer 12 to the flexible inlay 2. The specific composition of the product adhesion layer and/or cover adhesion layer may vary with respect to each other. In order not to add stability to the flexible electronic tag 1, the product adhesion layer 11 and the cover adhesion layer 13 can have precuts at the locations of the precuts of the flexible inlay 2.

The cover layer 12 is for example made of paper nylon, polyethylenterephthalat, polypropylene or a combination thereof. It as well has the precuts 6 at the same location if viewed from the top as it is shown in FIG. 2. The cover layer 12 can add protection of the flexible inlay 2, in particular the circuits 13, 15, and all the other parts of the flexible electronic tag 1. The flexible electronic tag 1 can be protected against dust, electrical discharge and humidity.

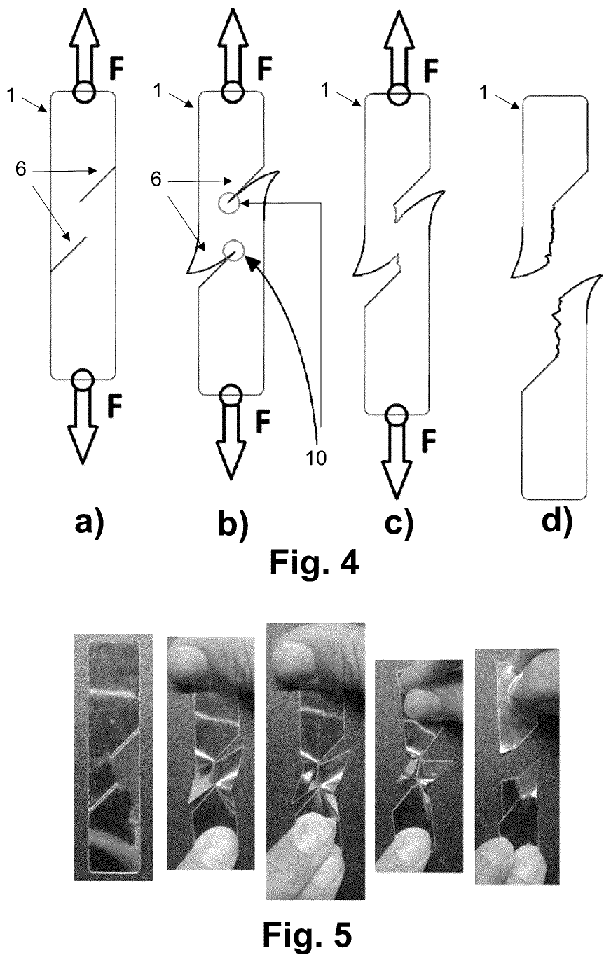

FIG. 4 shows a top-down view of a mechanical breaking of a flexible electronic tag 1, equivalent to FIG. 1, but for a flexible electronic tag 1 according to an embodiment of the disclosure. As with in FIG. 1, an outward directing force F is applied to the outer edges of the flexible electronic tag 1. Part a) shows a flexible electronic tag 1 just before the force F takes action. Part b) shows the force propagating to the place of weakest tear strength, shown as the place of tension concentration 10, which are the tips of the precuts 6. Part c) shows these tips or endpoints starting to tear at an applied force F. The required applied force F applied in this case is lower than the applied force F that would need to be applied in order to start a tear or slit in the case of having no precuts 6 for the same flexible electronic tag 1 as shown in FIG. 1. Part d) shows the flexible electronic tag 1 after completely being torn apart, the tear running between the two endpoints of the precuts 6, which are the places of tension concentration 10. Other paths of the tear are imaginable, but they start at one of the places of tension concentration 10.

FIG. 5 shows pictures from a top view of a mechanical breaking of a flexible electronic tag 1 by a pulling force F applied by two fingers on two opposite sides of the flexible electronic tag 1. The central figure shows the line of tension between the places of tension concentration 10. The last two figures show the tearing of the flexible electronic tag 1 from the upper place of tension concentration to its opposite side within the flexible electronic tag 1.

In one embodiment, the radio frequency identification circuit 3 is a passive radio frequency identification circuit 3 without a power source. In another embodiment, radio frequency identification circuit 3 is an active radio frequency identification circuit 3 comprising its own power source, for example a battery.

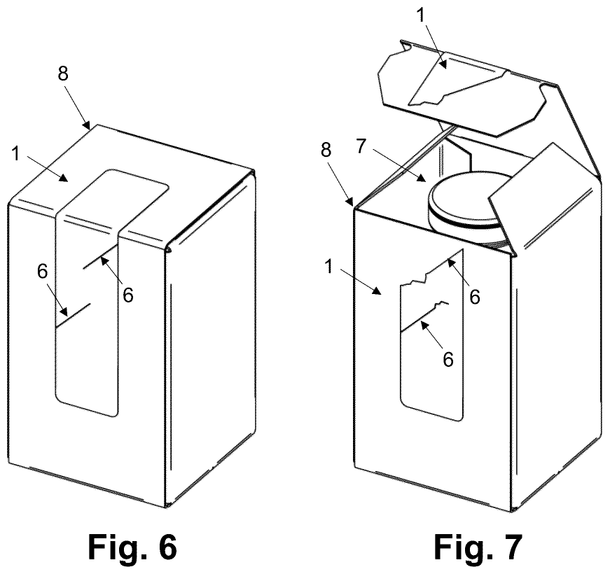

FIG. 6 shows schematically a packaging 8 of a product 7 (visible in FIG. 7). The packaging 8 comprises the flexible electronic tag 1 according to the present disclosure attached across a closed openable part of the packaging 8. In other words, the flexible electronic tag 1 is attached across an opening edge of the packaging 8.

FIG. 7 shows the packaging 8 of FIG. 7, wherein the packaging 8 has been opened. FIG. 7 further shows the product 7 arranged in the packaging. The product 7 is for example a medicine or a drug. FIG. 7 further shows that the flexible electronic tag 1 has been torn apart in two pieces along one of the precuts 6. FIG. 7 in particular shows that the precuts 6 enable to open the packaging with less force compared to standard tags without precuts. During the opening process the shear forces applied on the flexible electronic tag 1 are concentrated on the area of the tips of the precuts 6, which increase the local shear forces such that the flexible electronic tag 1 breaks along a virtual extension of at least two of the precuts 6. The required force to open the packaging 8 is advantageously reduces compared to standard electronic tags. It is therefore even possible for elderly people or for kids to open in an advantageous simple manner a packaging 8, which contains the desired product 7.

### LIST OF REFERENCE SYMBOLS

1 flexible electronic tag, RFID tag
2 flexible inlay
2a first portion
2b second portion
3 radio frequency identification circuit
4 antenna
5 tamper loop circuit
6 precut
7 product, consumer product
8 packaging
9 cross-sectional area
10 inner end/place of tension concentration
11 product adhesion layer
12 cover layer
13 cover adhesion layer

1. A flexible electronic tag for tamper detection, the flexible electronic tag comprising a radio frequency identification circuit and a tamper loop circuit connected to the radio frequency identification circuit, the flexible electronic tag further comprising:
a flexible inlay having a flat and elongated shape, comprising:
a first portion which comprises the radio frequency identification circuit, and
a second portion, which extends laterally from the first portion, and which comprises at least partially the tamper loop circuit),
at least two precuts, which extend from opposite outer edges of the second portion of the flexible inlay into the flexible inlay beyond the half width of the flexible inlay, and wherein the tamper loop circuit extends beyond the at least two precuts into the second portion of the flexible inlay.

2. The flexible electronic tag according to claim 1, wherein the radio frequency identification circuit is configured to detect, by the interrupted tamper loop circuit, attempted tampering.

3. The flexible electronic tag according to claim 1, one of: the radio frequency identification circuit or the tamper loop circuit is/are arranged within the flexible inlay.

4. The flexible electronic tag according to claim 1, wherein the flexible electronic tag comprises a product adhesion layer, which is arranged on a product side of the flexible inlay and which is configured to attach the flexible electronic tag to a product.

5. The flexible electronic tag according to claim 1, wherein the flexible electronic tag comprises a cover layer, which is configured to cover the flexible inlay, and wherein the flexible electronic tag further comprises a cover adhesion layer, which is arranged between the flexible inlay and the cover layer and which is configured to attach the cover layer to the flexible inlay.

6. The flexible electronic tag according to claim 5, wherein the cover layer comprises the same precuts as the flexible inlay.

7. The flexible electronic tag according to claim 1, wherein the flexible inlay is made of at least one of: Polyethylenterephthalate (PET), Polypropylene (PP), nylon plastics, or paper.

8. The flexible electronic tag according to claim 1, wherein the second portion of the flexible inlay has a substantially rectangular elongated shape.

9. The flexible electronic tag according to claim 1, wherein the precuts extend with respect to an edge of the flexible inlay perpendicular or at an acute angle into the second portion of the flexible inlay.

10. The flexible electronic tag according to claim 1, wherein the plurality of precuts extend parallel with respect to each other into the second portion.

11. The flexible electronic tag according to claim 1, wherein the tamper loop circuit is routed at least partially along a first side of at least one of the precuts, thereby following at least partially the shape of the at least one of the precuts.

12. The flexible electronic tag according to claim 11, wherein the tamper loop circuit is further routed around an inner end of the at least one of the precuts and at least partially along a second side, opposing to the first side, of the at least one of the precuts, thereby following at least partially the shape of the at least one of the precuts.

13. A packaging for a product comprising the flexible electronic tag according to claim 1, in particular attached across a closed openable part of the packaging.

14. A product comprising the flexible electronic tag according claim 1, in particular attached across a closed openable part of the product.
